(19) United States
(12) Patent Application Publication
(10) Pub. No.: US 2017/0103400 A1
(43) Pub. Date: Apr. 13, 2017

(54) CAPTURING AND IDENTIFYING IMPORTANT STEPS DURING THE TICKET RESOLUTION PROCESS

(71) Applicant: International Business Machines Corporation, Armonk, NY (US)

(72) Inventors: Vikas Agarwal, Noida (IN); Biplav Srivastava, Noida (IN); Srikanth Govindaraj Tamilselvam, Chennai (IN)

(21) Appl. No.: 14/881,568

(22) Filed: Oct. 13, 2015

(51) Int. Cl. G06Q 30/00

(52) U.S. Cl. CPC G06Q 30/016

(57) ABSTRACT

Methods and arrangements for a method of monitoring a ticket resolution process, said method including: utilizing at least one processor to execute computer code that performs the steps of: detecting, at a device, a ticket resolution initiation; capturing, based on the detection, user activity; identifying at least one work activity within the captured user activity; and storing, in a storage device, the at least one work activity. Other variants and embodiments are broadly contemplated herein.

### BACKGROUND

Customer service is vital for any service industry. The information technology sector is no different. When a customer submits a ticket (e.g., change ticket, incident ticket, problem ticket, etc.) companies are required to respond quickly and efficiently to these requests. Additionally, the ticket resolution process can be extremely specific depending on the type of ticket submitted. Depending on the complexity of a ticket, it may require an extensive amount of time from a subject matter expert to resolve. These unavoidable realities result in the ticket resolution process having the potential to be the highest operational cost a business accounts for.

The ticket resolution process typically involves multiple levels (e.g., receiving the ticket, initial investigation, resolution, completion, etc.), and a reduction in cost for any of those levels can be of great importance to any business that relies heavily on an information technology service. One key area available for improvement in most ticket resolution groups is the documentation process. Thus, in order to improve their overall business cost, companies need to improve their documentation, not only for easier review of the process as a whole, but to improve their accuracy and remove potential redundancies.

### BRIEF SUMMARY

In summary, one aspect of the invention provides a method of monitoring a ticket resolution process, said method comprising: utilizing at least one processor to execute computer code that performs the steps of: detecting, at a device, a ticket resolution initiation; capturing, based on the detection, user activity; identifying at least one work activity within the captured user activity; and storing, in a storage device, the at least one work activity.

Another aspect of the of the invention provides an apparatus for monitoring a ticket resolution process, said apparatus comprising: at least one processor; and a computer readable storage medium having computer readable program code embodied therewith and executable by the at least one processor, the computer readable program code comprising: computer readable program code that detects, at the apparatus, a ticket resolution initiation; computer readable program code that captures, based on the detection, user activity; computer readable program code that identifies at least one work activity within the captured user activity; and computer readable program code that stores, in a storage device, the at least one work activity.

An additional aspect of the invention provides a computer program product for monitoring a ticket resolution process, said computer program product comprising: a computer readable storage medium having computer readable program code embodied therewith, the computer readable program code comprising: computer readable program code that detects, at a device, a ticket resolution initiation; computer readable program code that captures, based on the detection, user activity; and computer readable program code that identifies at least one work activity within the captured user activity.

A further aspect of the invention provides a method comprising: detecting, at a device, a ticket resolution initiation; capturing, based on the detection, user activity, wherein the capturing comprises: recording, based on the detection, all user activity visible on a display device during the ticket resolution process; performing optical character recognition on the captured used activity; identifying at least one work activity within the captured user activity, wherein the identifying at least one work activity comprises at least one of: identifying, based on the captured user activity, if a work related tool was utilized; identifying, based on the captured user activity, if a contact associated with the user activity relates to a work activity; identifying, based on the captured user activity, if the user activity contains content related to a work activity; and storing, in a storage device, the at least one work activity in at least one of: text, image, and video.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates an embodiment of capturing and identifying important steps during the ticket resolution process.

FIG. 2 illustrates an embodiment ticket resolution involving multiple sessions and commands.

FIG. 3 illustrates an embodiment of user activity via a screen shot.

FIG. 4 illustrates another embodiment of user activity via a screen shot.

FIG. 5 illustrates another embodiment of user activity via a screen shot.

FIG. 6 illustrates another embodiment of user activity via a screen shot.

FIG. 7 illustrates another embodiment of user activity via a screen shot.

FIG. 8 illustrates another embodiment of user activity via a screen shot.

FIG. 9 illustrates another embodiment of user activity via a screen shot.

FIG. 10A illustrates another embodiment of user activity via a screen shot.

FIG. 10B illustrates another embodiment of user activity via a screen shot.

FIG. 11 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

Generally, documentation of ticket execution is a manual process. Agents typically receive a ticket request, process the request, and then upon finalization, record important steps or observations. However, precisely because this process is manual in nature, key information ends up being omitted from the ticket file. This omission can be for multiple reasons, for example, an agent may be rushed due to time constraints, work load, or the repetitive nature of the steps involved steps (e.g., being overlooked by the agent as being unimportant).

Additionally, current solutions require documentation to be almost exclusively in text format. This restriction causes the documentation process to be incomplete and/or ambiguous in nature. Thus, a solution is needed that allows the documentation process to go beyond text.

Therefore, an embodiment captures image(s) and/or video(s) in order to provide more clarity (i.e., more than text alone) during a ticket resolution process. An embodiment may capture user activities during the ticket resolution process using continuous video recording or a compilation of short timed snapshots. Based on this captured video/image data, an identification of ticket resolution activities is performed and the results are included in the ticket file as part of ticket resolution itself. In addition to video and image capturing, optical character recognition is performed on the collected user activity to identify key words or phrases (e.g., assignee, requesting client, ticket identification, etc.).

In a further embodiment, a ticket resolution initiation is detected (e.g., an agent manually activated the ticket resolution, a specific keyword or symbol associated with the initiation process is detected, etc.). This detection triggers the capturing of an agents activity (e.g., video, image, or textual data displayed on the agent's working screen). Once captured, these activity data are analyzed to filter non-work activities (e.g., chat, web browsing, family/friend email communications, etc.) from work activities (e.g., work email communications, ticket processing, etc.). Once the filtering process is complete, and the noise (e.g., non-work activity) is removed, and the work activity is stored with a specific ticket resolution.

In another embodiment, screenshots are obtained of every user activity at the end point of documentation. These screenshots capture all user activity at a workstation (e.g., email, browser usage, text documents, etc.). Once a ticket has been resolved, all of the existing screenshots are then compared against each other, and an embodiment filters out duplicate user activity in order to conserve disk space. The snapshots that are kept after the filtering process are then analyzed to determine available machine text in the images. Alternatively, an embodiment may use an optical character recognition (OCR) engine to identify any text within the captured user activity, and then based on the identified text compare the captured states to each other and filter out the duplicates. Additionally, based on user selection and input over time, an embodiment may learn, overtime, the difference between work related activities and non-work related activities and classify then accordingly.

Additionally, an embodiment may have prior knowledge of specific actions or tools that take place during the ticket resolution process and aid in the identifying work and non-work information (e.g., work tools, non-work tools, tools that can be used for both work and non-work, the typical start and end screen shown by a ticket management system, etc.).

The description now turns to the figures. The illustrated embodiments of the invention will be best understood by reference to the figures. The following description is intended only by way of example and simply illustrates certain selected exemplary embodiments of the invention as claimed herein.

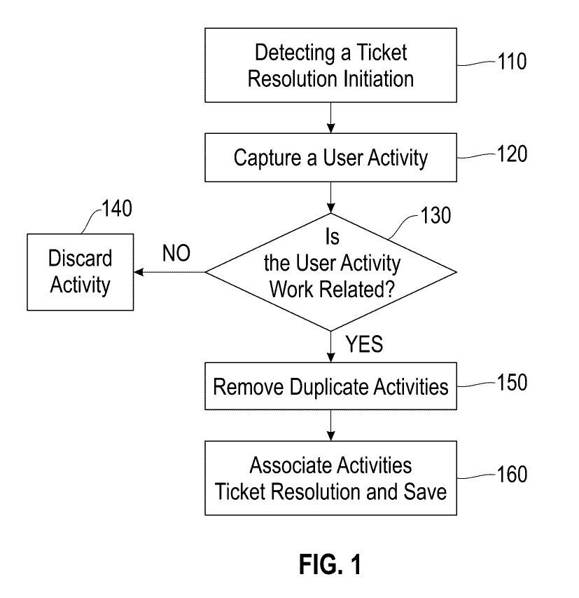

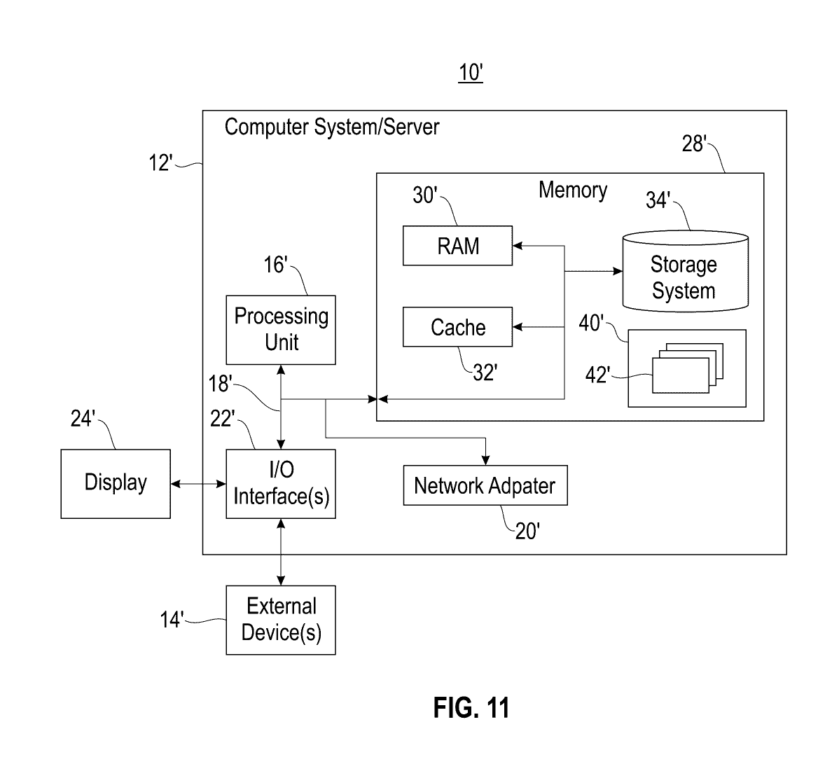

Specific reference will now be made here below to the figures. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 11. In accordance with an exemplary embodiment, most if not all of the process steps, components and outputs discussed with respect to FIG. 1 can be performed or utilized by way of a processing unit or units and system memory such as those indicated, respectively, at 16′ and 28′ in FIG. 11, whether on a server computer, a client computer, a node computer in a distributed network, or any combination thereof.

Broadly contemplated herein, in accordance with at least one embodiment of the invention are methods and arrangements which involve monitoring and collecting the work flow and methodology of an agent when resolving a ticket. This ensures a greater level of accuracy in the resolution documentation, and that adequate notes and records are kept of the entire process. Moreover, the collection of this information can assist in the creation of text documentation by completion of templates or questionnaires (e.g., a sequence number, an accessed tool, a type of activity performed, a time of performance, etc.). Collecting and creating a large repository of information can also assist a user or agent with resolution flow by matching current tasks to known related problems and their solutions, thereby alerting an agent when they deviate from a determined best practice. An even further embodiment may allow for an automated opening of related or required tools as well as enter any necessary information, thus greatly increasing the speed of the ticket resolution process.

Referring now to FIG. 1, ticket generation can come from multiple sources, for example, a user change request or user issue. Alternatively, the ticket could be derived from monitoring software that tracks information technology (IT) infrastructure and alerts a system administrator when an entity has failed (e.g., server disk crash, dependency application unavailable, etc.).

Regardless of the origin of the ticket, an embodiment may detect a ticket resolution initiation at 110. Typically, created tickets queue into a server management system accessible on a work station or terminal device (e.g., computer), and an agent (e.g., systems administrator or subject matter expert) processes the ticket queue at their work station. Once an agent selects a particular ticket to resolve, an embodiment may detect the initiation at 110. This initiation may be, for example, the agent opening a particular application, or selecting a particular mode of operation on the workstation. In a further embodiment, the work station might determine that the ticket initiation began by monitoring the desktop display and evaluating what is shown to the agent (e.g., identifying the title of the ticket resolution application in the application GUI).

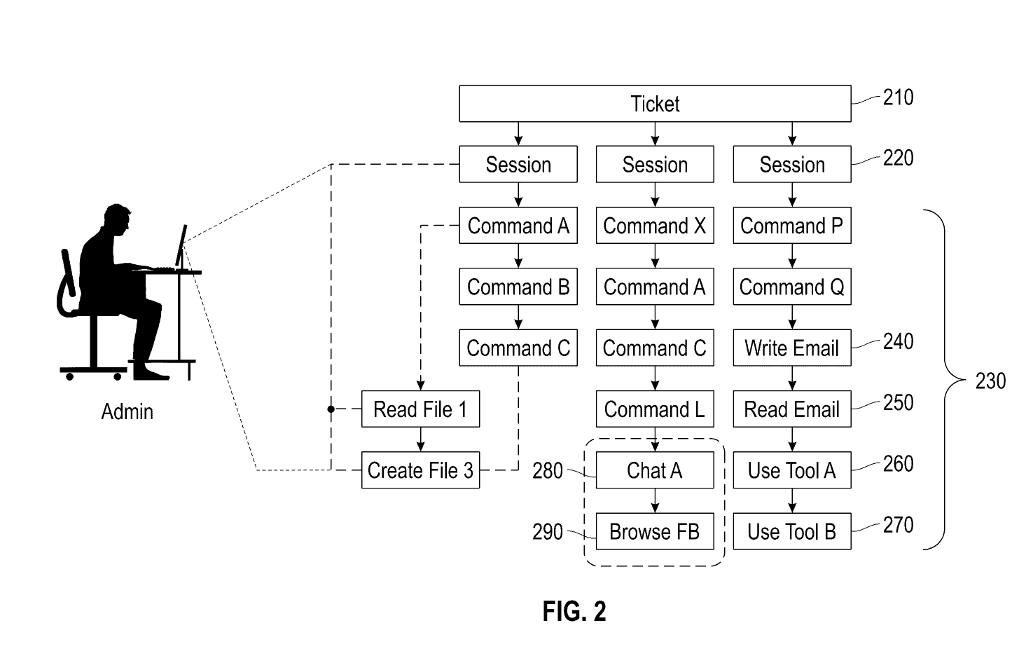

Referring briefly now to FIG. 2, a ticket at 210 may require a single or multiple sessions to resolve at 220. In an embodiment the multiple sessions may take place during the same resolution period (e.g., a single morning) or the ticket may require multiple days and multiple work sessions. Additionally, each session may involve multiple applications and various commands at 230. Referring back to FIG. 1, an embodiment must capture the entirety of the user activity at 120 regardless of time between sessions, or overall length of the resolution (e.g., the resolution stretches for three weeks with ten different log in sessions). An embodiment may capture the user activity at 120 via capturing all user activity visible on a display device (e.g., the agent's monitor) during the ticket resolution process. This capturing can take place using a snapshot or multiple snapshots at determined intervals during the resolution process (e.g., every two minutes). Alternatively, a video recording of the user activity may be captured and analyzed (e.g., in a frame by frame manner).

Once the resolution is initiated at 110, and the user activity is captured at 120, an embodiment determines if the captured user activity is work related or not at 130. This classification is done automatically through various methods. An embodiment may learn and classify work related tools based on known or learned information. This information may be, for example, specific application tool names, known internet protocol (IP) addresses of devices communicated with, known images (e.g., screen captures) that have been associated with a particular action, particular application title, etc. A further embodiment may initialize a model in memory that is associated with words (e.g., domain words) obtained from an initial ticket record. Thus, as a user or users perform activities, words can be compared against the model and only those activates that match a particular subset of the words stored in memory are classified as work related.

Some of the key factors in determining if a user activity comprises work activity are: tool identification, contact identification, and content matching. These methods as well as others are discussed at length herein. In addition to utilizing these factors, an embodiment may weight the factors in an effort to more accurately predict work and non-work activities. Therefore, an embodiment may use a heuristic based weighting methodology which characterizes the three factors and assigns a value from within a predetermined range. For example, a factor associated with tool identification may have a max value of 0.4, whereby 0.4 would be for a pre-classified work tool, 0.2 for a potential work tool, and 0.0 for a non-work tool. In an additional embodiment, the contact information (e.g., an email address, phone number, contact name, etc.), may have a max value of 0.3 indicating, for example, an email matching the identification of a client or ticket requester, thus given the full value. When determining the value related to content matching, an embodiment may use a max of 0.3. The content matching may be based on a user setting (e.g., setting a maximum or minimum threshold for an activity to be considered work related). Alternatively, an embodiment may base content matching on experiments (e.g., trial and error) and may be adjusted (e.g., by a user or automatically) in a long term process to attain the best possible performance. Although only a limited selection of example factors are presented herewith, one skilled in the art would recognize many factors may be utilized in the determination process.

Referring back to FIG. 2, an embodiment shows an agent responding to a ticket 210, and performing a variety of actions at 230. An embodiment then classifies those actions based on the captured information. For example, if a user is writing a work email at 240, an embodiment may analyze the captured data (e.g., content) relating to the email to determine if the email is work related. In the current illustrated embodiment, FIG. 2 shows actions that an agent may typically engage in such as writing an email at 240, reading an email at 250, using a particular application tool at 260 and 270, using a chat application to chat with another individual at 280, and browsing FACEBOOK at 290. FACEBOOK is a registered trademark of Facebook, Inc. in the United States of America and other countries. An embodiment may determine based on a variety of factors, as discussed herein, that 240-270 comprised work related activity, but 280 and 290 did not. Thus, the information captured related to 240-270 is passed on in the process, but the information captured at 280 and 290 is discarded at 140 of FIG. 1.

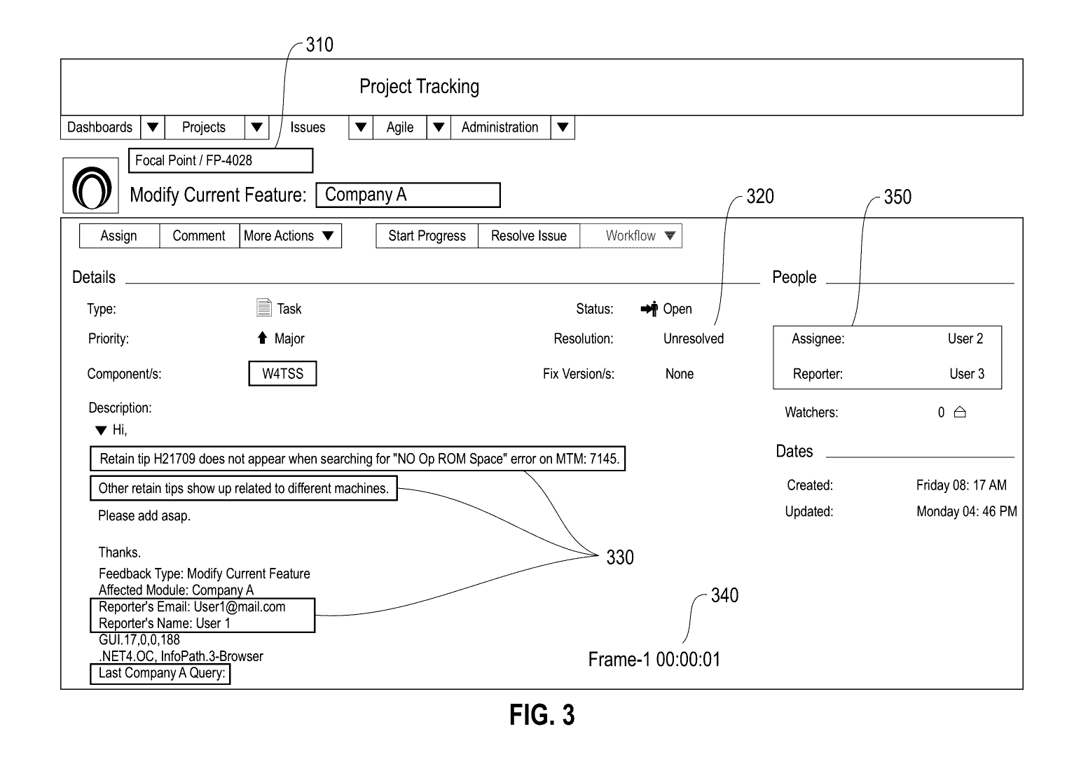

Reference will now be made to FIGS. 3-8 that illustrate embodiments of possible steps of user activity, which may be captured during a ticket resolution process. FIG. 3 shows an embodiment ticket management system. Thus, an embodiment may initialize the capture process based on detected information, for example, a ticket identification number, such as that at 310, combined with a resolution status of “unresolved” at 320. Thus, for example, an embodiment may know the request, the issue, the identity of the requester, etc. are displayed at a certain locations on the screen, such as that at 330 and the assignee and reporter at 350. Alternatively, an embodiment may determine from the context clues within captured user activity what the recognized text represents (e.g., a customer request/issue).

Additionally or alternatively, the initiation of the ticket resolution process may be triggered manually via the agent activating the recording/capture option. During the capture process, an embodiment may identify the frames and associate them with a recorded time stamp at 340. This allows an embodiment to determine proper workflow and keep a more accurate record by improving duplicate recognition (as discussed herein).

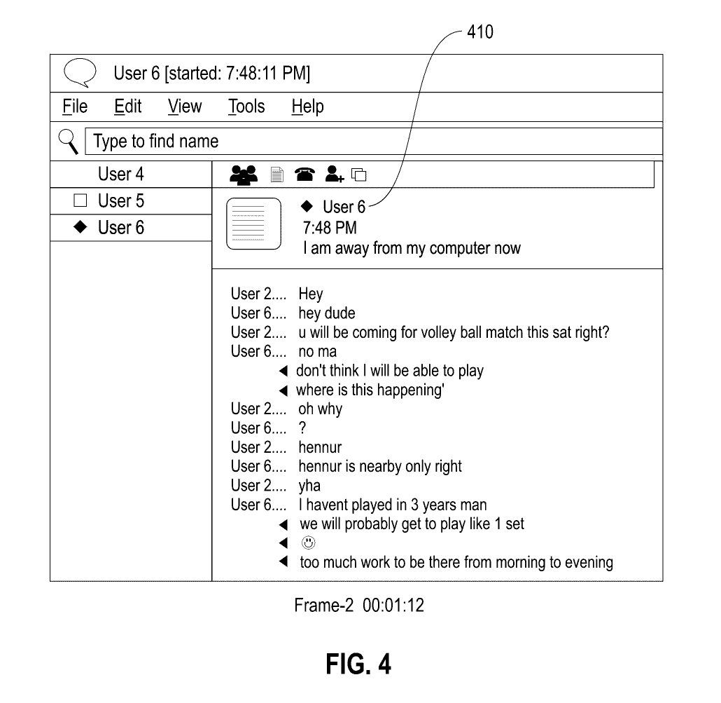

FIG. 4 shows an embodiment of captured user activity. As discussed herein, an embodiment may have previous knowledge of what applications are work related and what are not. The embodiment illustrated in FIG. 4 is a chat application, which can be used both for work and non-work purposes. Thus, an embodiment must make a further assessment based on the captured user activity (e.g., contact and content of communication). Although the application can be used for work activities, an embodiment may evaluate the contact at 410. An embodiment may determine that the contact does have a pending ticket, however, based on the determined content of the communication (e.g., that it relates to recreational activities such as volleyball), the weighting system may determine that this user activity is non-work related.

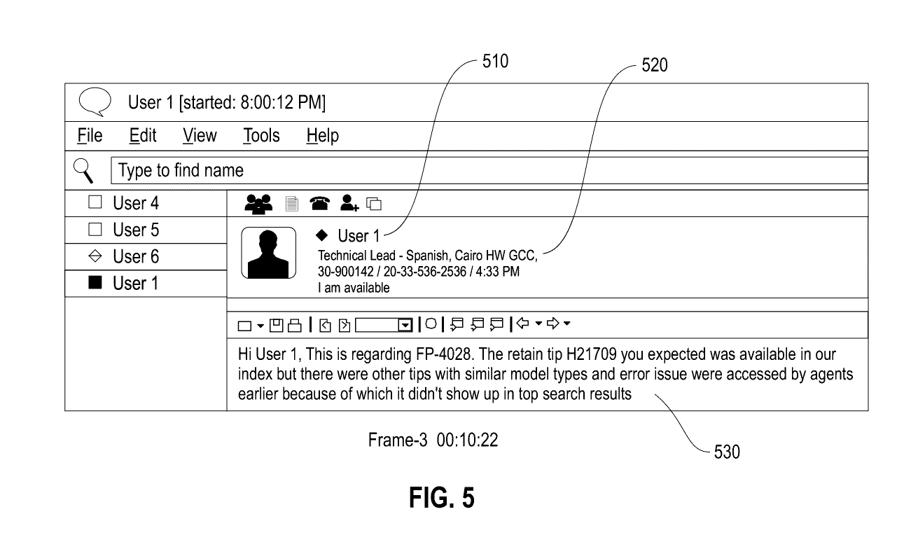

Alternatively, FIG. 5 shows an embodiment where an agent is in communication with a co-worker. Similar to FIG. 4, the agent is utilizing a tool that can be used for both work and non-work activities, so a more detailed examination is required. Here, the contact “user 1” at 510 is the same contact recorded from Frame 1 (FIG. 3) that submitted the ticket currently being worked by the agent. Additionally, an embodiment may identify the job numbers at 520 and 530 associated with a particular ticket included in the subject or body of an email (e.g., FP-4028). Thus, based on the contact as well as the content of the email, an embodiment may then determine that it is very likely work related user activity and thus not discard it.

Image and video data can be extremely large, especially when stored in large quantities (e.g., many per ticket resolution), and the cost of maintaining this record can become inefficient. Thus, once a determination is made regarding whether user activity is work or non-work, an embodiment may analyze the remaining stored information to identify duplicates, redundancies, or non-essential snapshots of the information at 150.

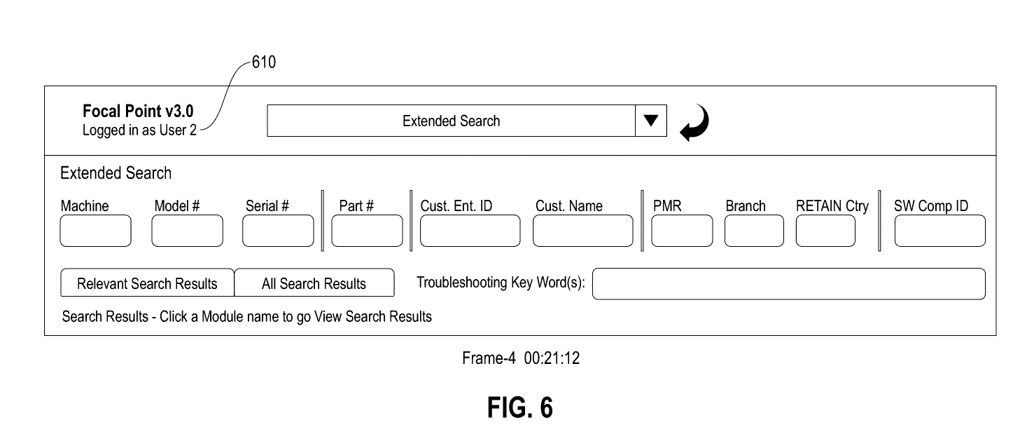

Referring now to FIG. 6 an illustrated embodiment snapshot (e.g., Frame 4 captured at 00:21:12 of the process) of user activity is shown that does not contain any ticket specific data. However, because the application is identified as a work application and the user identification at 610 is identified as the assignee (e.g., “user 2”), displayed in FIG. 3 at 350, an embodiment identifies this information as work related activity and stores it. Alternatively, a further embodiment may identify this activity snapshot as containing no relevant information and thus skip or fail to include the frame in the data associated with the ticket resolution process. Initially, a user can annotate to skip such frames, and an embodiment may learn over time based on user preference what information is relevant and thus worth recording.

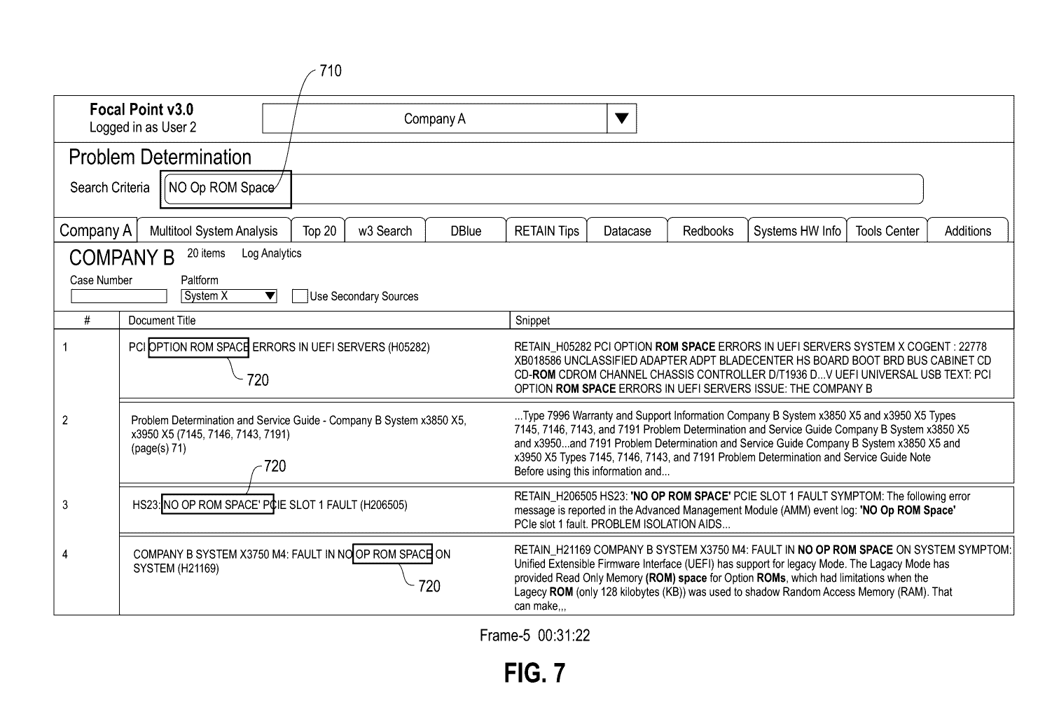

Referring now to FIG. 7, an illustrated embodiment snapshot (e.g., Frame 5 captured at 00:31:22 of the process) of user activity is shown after a search has been carried out based on the identified problem (e.g., NO Op ROM Space at 710), the identified problem being captured in FIG. 3 at 330. Thus, as before, the application is identified as work related, the user is identified as the assignee, and at multiple points in the screenshot, text (e.g., content) that is closely associated with the current ticket is present. Thus, based on those three factors, an embodiment may determine that it is both work related information, and that the snapshot includes specific information related to the ticket resolution process (e.g., a search of the identified problem and potential results at 720).

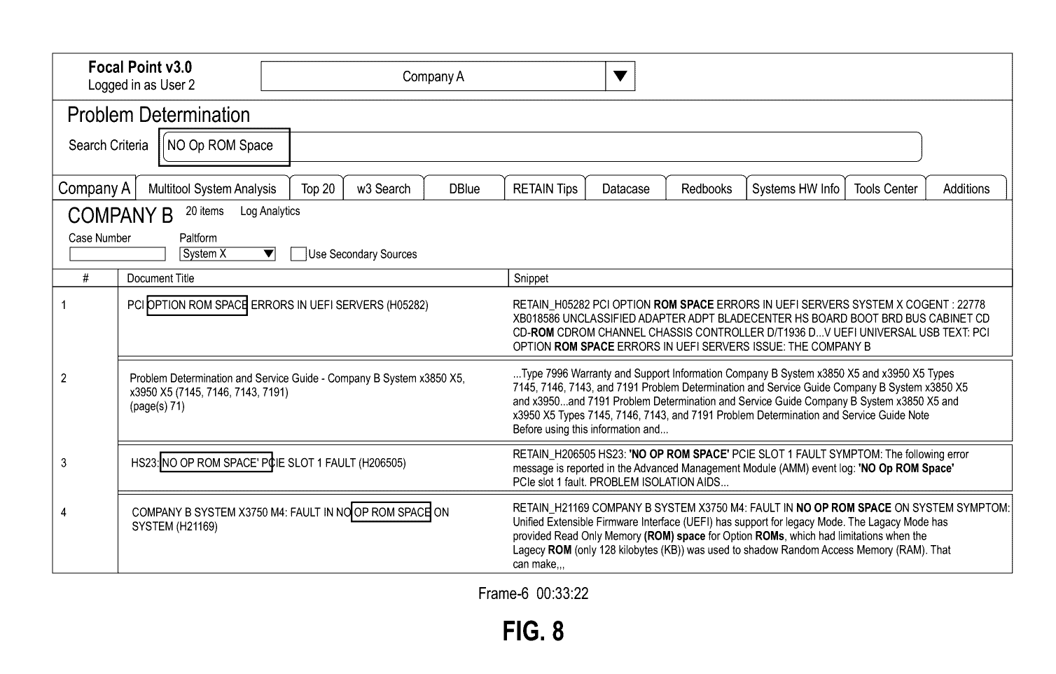

In addition to determining if captured user activity contains useful information, an embodiment may identify redundancies within the captured information and eliminate those redundancies to conserve disk space. For example, referring to FIG. 8, a new frame (i.e., Frame-6) is captured at 33 min and 22 seconds into the process. Thus, approximately two minutes have elapsed from the capturing of the previous frame (i.e., Frame-5). Although the embodiment of FIG. 8, similar to FIG. 7, contains relevant information, the embodiment can determine that no new information is contained within the snapshot when compared to the previous snapshot. Thus, an embodiment may remove the duplicate captured user activity at 150 to conserve disk space.

A further embodiment may filter duplicate screenshots by retaining the most informative screenshot for each activity or step of the process. For example, an embodiment may first identify the frame which captures a new window based on the window title (e.g., Content Analytics). An embodiment may then search within this range (e.g., all snapshots with a similar window title) to find similarity between consecutive frames. When a snapshot is determined to be significantly different (e.g., the same window is viewed, but the view has been scrolled down has different set of fields) an embodiment may segregate the different window. The significant difference can be adjusted based on user preference through specifically implemented rules, or a machine learned process based on previous user annotation.

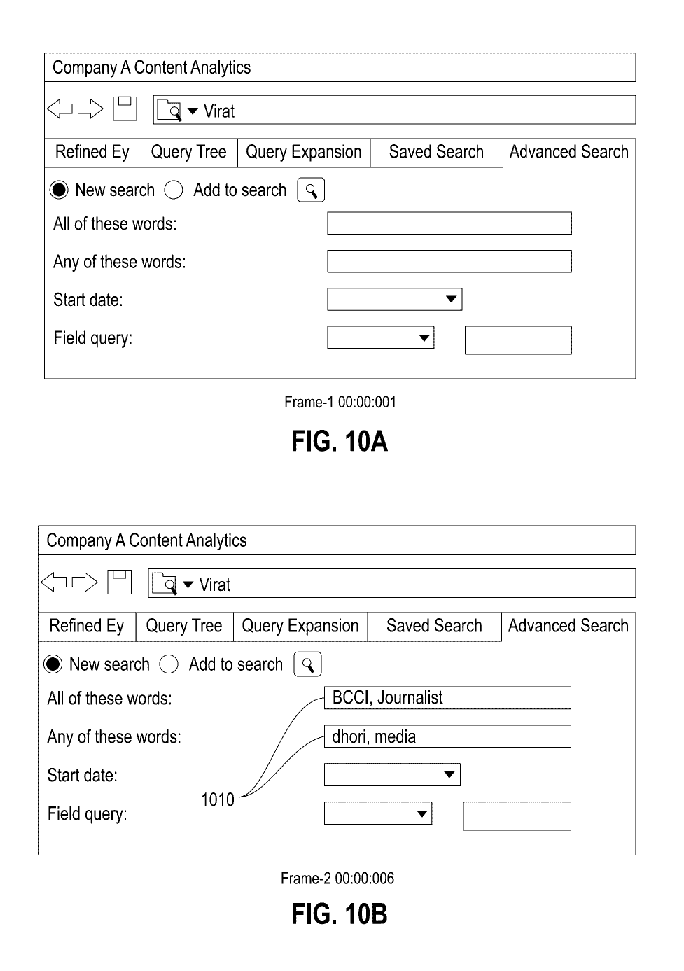

Turning briefly to FIGS. 10A and 10B, a further embodiment may then look at those snapshots determined to be similar, and select the frame with the latest timestamp. The selected frame is then considered to comprise the information contained within the previously identified similar frames. For example, FIG. 10A (i.e., Frame-1) and FIG. 10B (i.e., Frame-2) may come from the same window, but the later captured Frame-2 has a slight variation or updated field at 1010 from the previous window and thus Frame-2 is retained for summarization as it contains all of the information of Frame-1 plus the additional information at 1010.

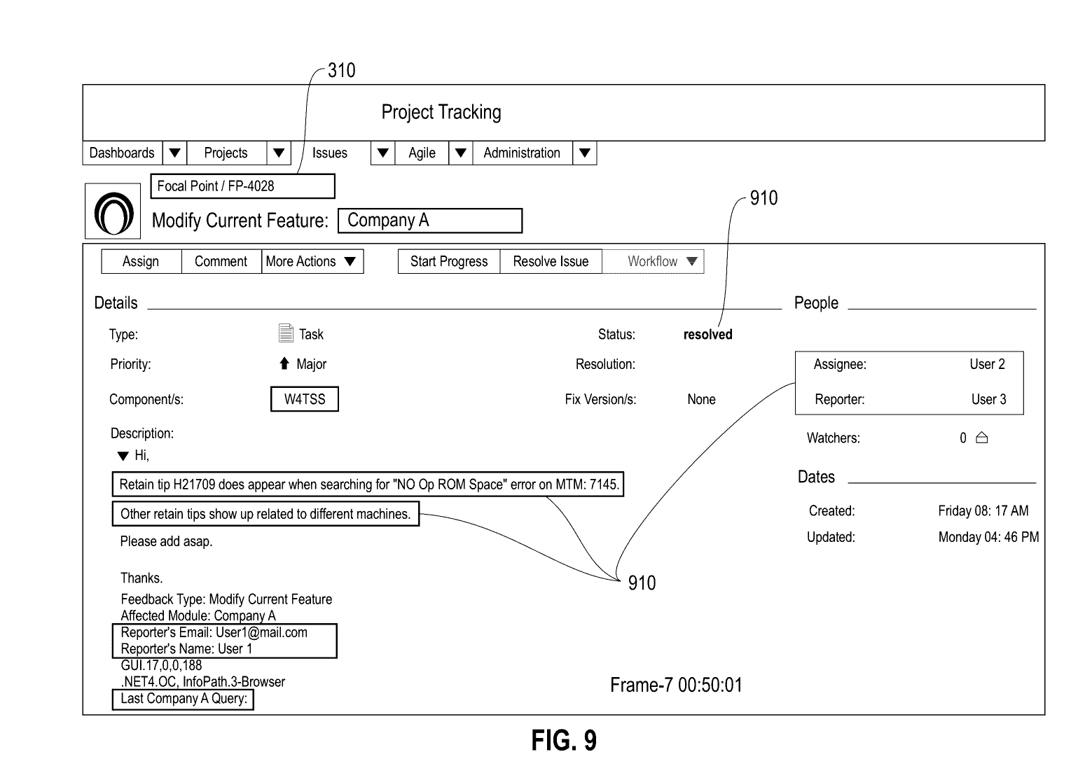

Referring now to FIG. 9, as discussed herein, an embodiment may use OCR to determine what content or context clues are available in the captured user activity. For example, an embodiment may determine that the status of the ticket has been updated to “resolved” at 910. Additionally, an embodiment may verify which ticket the changed status is associated with via comparing the detected information at 920, with the previously captured ticket information (e.g., that at 330).

Once the ticket is resolved or closed, an embodiment may associate captured user activity with the resolved ticket and store both in storage device at 160. The stored information may be stored in any available format (e.g., image, video, text (based on the OCR), etc.). Additionally or alternatively, an embodiment may convert any captured image or video data into text for storage. A further embodiment may store the captured user activity on a local or remote storage device. The storage device may also be accessible to other users or the same user on subsequent sessions. This stored user activity may then be utilized for a variety of factors.

One embodiment may assist in text documentation. Because an embodiment records user activities as image/video, it may convert the recorded information into text for documentation purposes (e.g., factors like the active window or application, time duration, user accessed fields, etc.). As a further embodiment, FIG. 10B (i.e., Frame-2) may be described as “Resolution Step: Open<Window>‘Company A Content Analytics’<Name>, enter<User activity write/browse/touch>All of these words ‘BCCI, Journalist’, Any of these fields ‘dhoni media’. Time spent 00.00:06”. Additionally or alternatively, an embodiment may help populate most of the template like data fields (e.g., window title, abstract activity, time spent etc.).

An additional embodiment may assist in ticket resolution. For example, once a ticket type (e.g., change ticket, incident ticket, problem ticket, etc.) is identified via comparing the current user activity with historical user activity associated with historical tickets, an embodiment may open or preload all involved tools in the previously resolved ticket and populate these tools with known default values (based on the historical data). For example, an issue, from a ticket repository tool may relate to a particular machine type mentioned or application which is by default opened. Similarly, other related pages or applications can be opened with the knowledge acquired via the historical user activity.

Referring now to FIG. 11, a schematic of an example of a computing node is shown. Computing node 10′ is only one example of a suitable computing node and is not intended to suggest any limitation as to the scope of use or functionality of embodiments of the invention described herein. Regardless, computing node 10′ is capable of being implemented and/or performing any of the functionality set forth hereinabove. In accordance with embodiments of the invention, computing node 10′ may be part of a cloud network or could be part of another type of distributed or other network (e.g., it could represent an enterprise server), or could represent a stand-alone node.

In computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of monitoring a ticket resolution process, said method comprising:
utilizing at least one processor to execute computer code that performs the steps of:
detecting, at a device, a ticket resolution initiation;
capturing, based on the detection, user activity;
identifying at least one work activity within the captured user activity; and
storing, in a storage device, the at least one work activity.

2. The method according to claim 1, wherein the identifying at least one work activity comprises at least one of:
identifying, based on the captured user activity, if a work related tool was utilized;
identifying, based on the captured user activity, if a contact associated with the user activity is a work contact; and
identifying, based on the captured user activity, if the user activity contains content related to a work activity.

3. The method according to claim 2, wherein factors used to identify work related activity are weighted.

4. The method according to claim 1, wherein the capturing comprises: recording, based on the detection, all user activity visible on a display device during the ticket resolution process.

5. The method according to claim 1, wherein the capturing comprises: capturing, based on the detection, at least one screen snapshot at at least one predetermined time interval during the ticket resolution.

6. The method according to claim 1, comprising: performing optical character recognition on the captured used activity.

7. The method according to claim 1, further comprising: populating, based on previously recorded user activity, a data field associated with a work activity.

8. The method according to claim 1, further comprising closing the ticket resolution, based on identifying a characteristic on a display device indicating a ticket resolution.

9. The method according to claim 1, wherein the storing the at least one work activity comprises: storing the at least one work activity in at least one of: text format, image format, and video format.

10. An apparatus for monitoring a ticket resolution process said apparatus comprising:
at least one processor; and
a computer readable storage medium having computer readable program code embodied therewith and executable by the at least one processor, the computer readable program code comprising:
computer readable program code that detects, at the apparatus, a ticket resolution initiation;
computer readable program code that captures, based on the detection, user activity;
computer readable program code that identifies at least one work activity within the captured user activity; and
computer readable program code that stores, in a storage device, the at least one work activity.

11. A computer program product for monitoring a ticket resolution process, said computer program product comprising:
a computer readable storage medium having computer readable program code embodied therewith, the computer readable program code comprising:
computer readable program code that detects, at a device, a ticket resolution initiation;
computer readable program code that captures, based on the detection, user activity; and
computer readable program code that identifies at least one work activity within the captured user activity.

12. The computer program product according to claim 11, wherein the identifying at least one work activity comprises at least one of:
identifying, based on the captured user activity, if a work related tool was utilized;
identifying, based on the captured user activity, if a contact associated with the user activity is a work contact; and
identifying, based on the captured user activity, if the user activity contains content related to a work activity.

13. The computer program product according to claim 12, wherein factors used to identify work related activity are weighted.

14. The computer program product according to claim 11, wherein the capturing comprises: recording, based on the detection, all user activity visible on a display device during the ticket resolution process.

15. The computer program product according to claim 11, wherein the capturing comprises: capturing, based on the detection, at least one screen snapshot at at least one predetermined time interval during the ticket resolution.

16. The computer program product according to claim 11, wherein the computer readable program code further comprises:
computer readable program code that performs optical character recognition on the captured used activity.

17. The computer program product according to claim 11, wherein the computer readable program code further comprises:
computer readable program code that populates, based on previously recorded user activity, a data field associated with a work activity.

18. The computer program product according to claim 11, wherein the computer readable program code further comprises:
computer readable program code that closes the ticket resolution, based on identifying a characteristic on a display device indicating a ticket resolution.

19. The computer program product according to claim 11, wherein the storing the at least one work activity comprises: storing the at least one work activity in at least one of: text format, image format, and video format.

20. A method comprising:
detecting, at a device, a ticket resolution initiation;
capturing, based on the detection, user activity, wherein the capturing comprises: recording, based on the detection, all user activity visible on a display device during the ticket resolution process;
performing optical character recognition on the captured used activity;
identifying at least one work activity within the captured user activity, wherein the identifying at least one work activity comprises at least one of:
identifying, based on the captured user activity, if a work related tool was utilized;
identifying, based on the captured user activity, if a contact associated with the user activity relates to a work activity;
identifying, based on the captured user activity, if the user activity contains content related to a work activity; and
storing, in a storage device, the at least one work activity in at least one of: text, image, and video.
